(19) United States
(12) Patent Application Publication
(10) Pub. No.: US 2004/0202222 A1
(43) Pub. Date: Oct. 14, 2004

(54) Solid state laser gyro comprising a resonator block

(76) Inventors: Jean Paul Pocholle, La Norville (FR); Pierre Gallon, Vouneuil Sur Vienne (FR); Jacques Leclerc, Valence (FR); Herve Girault, Neuilly Sur Seine (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/478,988

(22) PCT Filed: May 28, 2002
(86) PCT No.: PCT/FR02/01792

(30) Foreign Application Priority Data
May 30, 2001 (FR) 01 07266

(51) Int. Cl. H01S 3/091

(52) U.S. Cl. 372/75

(57) ABSTRACT

The solid-state laser gyro of the invention comprises a solid-state resonator block, in which an optical path followed by two counterrotating waves generated by an optical-gain laser medium is defined, and, according to an important characteristic, the gain medium is attached to the resonator and is made of a rare-earth-doped crystal.

The present invention relates to a solid-state laser gyro comprising a resonator block.

Monolithic gyros using a solid-state medium as laser source are known, for example from U.S. Pat. No. 5,960,022. That patent discloses a gyro in which the resonant cavity is produced from an entirely doped optical material, which makes it difficult to produce if it is desirable for it to have uniform properties. Moreover, this type of laser uses a not insignificant volume of doped materials, which makes it expensive, and is subject to drift with variations in ambient temperature.

Also taught, from document U.S. Pat. No. 5,367,377, is a nonplanar cavity gyro, which, in the presence of a magnetic field, makes it possible to obtain four counterpropagating cavity modes, making it possible to produce a double-cavity laser gyro. The cavity described in that document, being nonplanar, is difficult to manufacture and to adjust (the alignment of the various optical elements of the cavity is critical). In addition, the presence in the cavity of a magnetic-field-sensitive element means that the cavity must be provided with very effective shielding, which is very expensive. The gain medium is placed in one of the arms of the ring cavity, which complicates manufacture.

The object of the present invention is a solid-state laser gyro that is easy to produce, is inexpensive, uses a small volume of active material and is temperature-stable.

The laser gyro according to the invention includes a resonator block, in which an optical path followed by two counterrotating waves generated by an optical-gain laser medium is defined, and it is characterized in that the block is planar and the gain medium is attached to the resonator block.

According to a preferred aspect of the invention, the resonator block is made of an undoped material. This block includes machined optical channels. The gain medium is a rare-earth-doped crystal and is pumped by a diode laser. As a variant, this gain medium may be pumped directly by electrical means.

The present invention will be more clearly understood on reading the detailed description of several embodiments, given by way of non-limiting examples and illustrated by the appended drawing, in which:

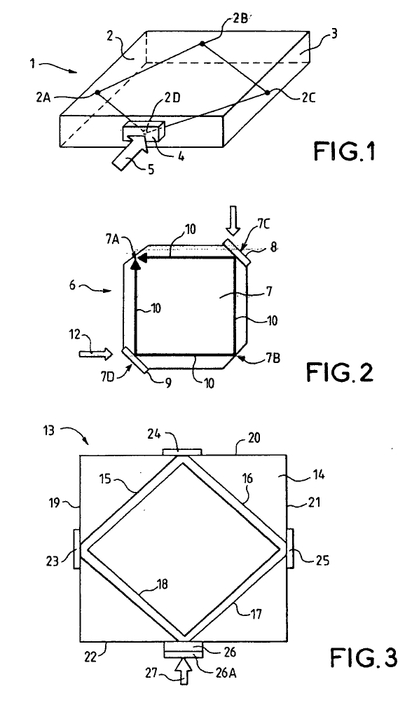

FIGS. 1 and 2 are basic diagrams showing a laser gyro structure according to the invention;

FIG. 3 is a simplified plan view of a gyro structure according to the invention;

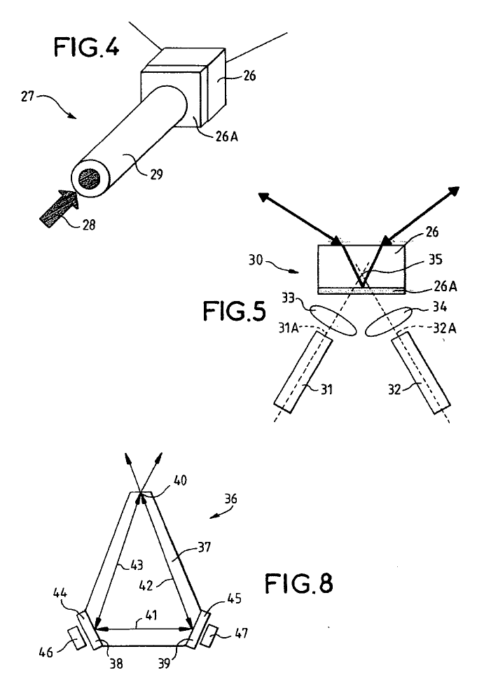

FIGS. 4 and 5 are simplified views of optical pumping devices that can be used in the gyro of the invention;

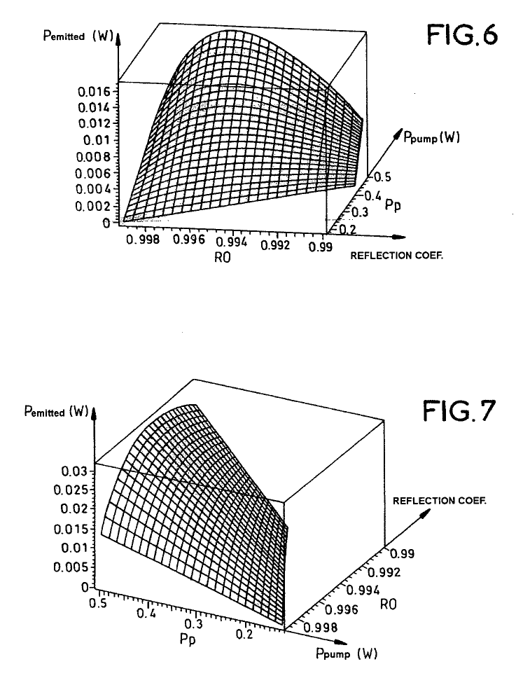

FIGS. 6 and 7 are graphs of the variation in emitted laser oscillation power as a function of the incident pumping power and of the reflection coefficient of the output mirror, for different thicknesses of the structure according to the invention; and

FIG. 8 is a simplified plan view of an alternative embodiment of the structure according to the invention.

The laser gyro device according to the invention makes use of the laser emission properties of rare earths when they are inserted into a host matrix defining an optical cavity and are excited by an optical pumping process.

A few basic concepts pertaining to ring cavity gyros will be recalled here. When a cavity is motionless, the angular frequency ωₘ of the field associated with a longitudinal mode is obtained by the equation:

ωₘL/c=2πm.

In this equation, L is the length of the cavity perimeter, c is the speed of light in the medium present in the cavity and m is the integral number of wavelengths λₘ contained in a cavity perimeter, m being such that:

$$( \frac{L}{{λ}_{m}} = m )$$

Therefore:

ωₘ=2λmc/L.

If the cavity undergoes a rotational motion with an angular velocity Ω about an axis perpendicular to the main axis of the cavity and passing through its center, the copropagating and counterpropagating waves (rotating in the same direction as the cavity and in the opposite direction, respectively) undergo the Sagnac effect.

This effect is equivalent to a change in the distance traveled by the two waves (the distance is increased by δL in the case of the copropagating wave and decreased by δL in the opposite direction). This effect is accompanied by a change in the angular frequencies associated with the waves, depending on their direction of propagation in the cavity (an increase in the angular frequency ωₘ⁻ in the opposite direction from that of the cavity rotation and a reduction in the angular frequency ωₘ⁺ in the direction of the rotation). Thus:

ωₘ⁻−ωₘ⁺=2ωₘδL/L,

where δL is proportional to the speed of rotation Ω, which, according to the Sagnac equation, takes the form:

Δω=ωₘ⁻−ωₘ⁺4SωₘΩ/L,

S being the surface circumscribed by the ring that forms the cavity and L being the length of that ring.

From this equation it is possible to define a scale factor F such that:

F=Δω/Ω=4Sω/Lc=8πS/λL.

Thus, by making the two waves that travel in the resonator ring in opposite directions interfere with each other, it is possible to obtain a beat signal that corresponds to the frequency shift induced by the rotation of the laser cavity.

FIG. 1 shows the basic diagram of a laser gyro 1 produced entirely from solid-state components. The cavity 2 is planar and of rectangular annular shape. It is produced in an optical block 3 in the form of a thin rectangular plate (with the thickness of a few millimeters for example), while the other dimensions of the block are considerably larger (for example of the order of 10 cm or more). The four vertices of the rectangle formed by the cavity coincide with the centers of the side faces of the block. Three of these vertices, 2A, 2B and 2C, are such that there is total reflection of the laser beams traveling around the cavity, while the fourth vertex 2D has a slab 4 of rare-earth-doped optical-gain material fixed directly to the corresponding side face of the block 3 and coupled to an optical pumping device 5, which also consists of a solid-state component.

FIG. 2 shows the basic diagram of an alternative embodiment 6 of the gyro of FIG. 1. This gyro 6 is produced from a block 7 of optical material, the thickness of which is also small compared to its other dimensions. This block is in the form of a rectangular parallelepiped whose four lateral corners have been removed. Two of the opposed surfaces 7A, 7B thus created remain bare, whereas the other two surfaces 7C and 7D are provided with slabs 8 and 9 made of semiconductor material or a material of the rare-earth-doped dielectric crystal type, forming the optical-gain active medium. An annular optical cavity 10 is formed between the successive centers of the surfaces 7A, 7C, 7B and 7D. Thus, a symmetrical structure is obtained, this being symmetrical with respect to the diagonals joining the centers of the surfaces 7A, 7B and 7C, 7D).

Pumping devices 11 and 12 are coupled to the slabs 8 and 9 respectively. These devices 11 and 12 are placed symmetrically with respect to the diagonal joining the centers of the surfaces 7A, 7B, so as to act on the optical paths that start from these centers in opposite directions.

FIG. 3 shows an embodiment of a laser gyro adopting the principle of FIG. 1. This gyro 13 is produced from a block 14 of material having a very low thermal expansion coefficient, for example from “ZERODUR”. Machined in this block 14 are four narrow channels 15 to 18 that join the centers of the consecutive side faces 19 through 22 of this block respectively. These channels have, for example, a cylindrical cross section with a diameter of about 1 mm. Mirrors 23 to 25 are fixed to the centers of the faces 19 to 21 and an “active mirror” 26 is fixed to the center of the face 22, said active mirror consisting of one or more wafers of solid-state laser material, for example Nd³⁺:YVO₄. This wafer (or all the wafers) has (have), on its (their) face on the opposite side from that which is applied against the block 14, a mirror having a maximum reflection coefficient at the oscillation wavelength in the ring cavity (formed by the segments 15 through 18) at the angle of incidence on this mirror that is set by the geometry of this ring. On its side applied against the block 14, the wafer 26 has an antireflection coating. This wafer 26 is coupled to a pumping device 27.

By using a material such as “Zerodur” to produce the block 14, the manufacturing cost of the gyro is lowered and the cavity, of almost monolithic structure, exhibits excellent thermooptical stability. Of course, it is possible to use materials other than “Zerodur” that have similar properties, for example fused silica. The channels 15 to 18 may be filled with an inert gas at a pressure that depends on the field of use of the gyro (atmospheric pressure or a different pressure). This gas may be nitrogen or purified air, for example. The sole selection criterion for this gas (or inert gas mixture) is the absence of an absorption band at the working wavelength.

The invention also applies to the production of a triaxial gyroscopic system, by combining three devices such as those described above, the planes of which are pairwise mutually perpendicular.

In all the embodiments of the gyro of the invention, the spatial filtering or the transverse laser mode selection is able to be effected by changing, in a manner known per se, the diameter of the channels 15 through 18 and/or some of the characteristics of the optical pumping 27.

The laser material of the wafer (or wafers) 26 is preferably a uniaxial crystal of yttrium vanadate doped with the rare earth ion Nd³⁺.

This material is beneficial because of the following advantages that it offers:

the laser emission is naturally polarized;

compared to materials such as yttrium garnet (YAG), it has a higher effective cross section for absorption and for emission, thereby making it possible to achieve a high optical gain, even for small thicknesses of the microwafer;

the relatively narrow gain spectrum (bandwidth) (for example: bandwidth of approximately 5 nm at a wavelength of approximately 1.064 nm) allows the laser to be operated in pulsed mode; and

the spectral width of the absorption band reduces the sensitivity of the diode pump laser to wavelength drift. By way of indication, the absorption coefficient at the pumping wavelength of 808 nm is 30 cm⁻¹. In such a case, the thickness of the microwafer must be around 300 μm.

To produce the microwafers 26, it is also possible to use an Nd:YAG crystal at an oscillation wavelength of 1.064 nm. In such a case, this crystal can be doped with 1.1 at % of Nd³⁺, making it possible to obtain a high optical gain coefficient for a small crystal thickness. Typically, the absorption coefficient is 6 cm⁻¹, which gives an Nd:YAG thickness of about 1.5 mm. It is also conceivable to use a glass wafer codoped with Yb and Er, making it possible to produce an oscillator at 1.54 μm.

FIG. 4 shows the basic diagram of the device 27 for the longitudinal pumping of the microwafer 26 of FIG. 3 via an optical fiber. For this purpose, the pump 28 (one or more diode lasers) acts on a single multimode optical fiber 29 that terminates in the part 26A forming the mirror of the wafer 26.

In the embodiment shown in FIG. 5, the device 30 for optically pumping the wafer 26 comprises two optical fibers 31 and 32 that are coupled to this wafer 26 via convergent lenses 33 and 34 respectively. The output axes 31A, 32A of the fibers 31, 32 are oriented so as to converge on a point 35 in such a way that maximum optical energy is injected into the channels that terminate in the wafer 26 (channels 17 and 18 in FIG. 3). Thus, the overlap integral between the cavity mode and the spatial distribution of the pumping energy (that is to say the gain) is optimized. This device 30 also provides spatial filtering of the cavity mode, when the cavity is oscillating, thanks to this optimization of the overlap integrals.

In the case of the ring cavity shown in FIG. 2, it is possible to evaluate the pumping power levels that need to be used in order to obtain laser oscillation. To give an illustrative example, a ring cavity may be considered in which each channel (forming part of the channels labeled 10 in FIG. 2) has an optical length of 10 cm, the mirrors formed at the four corners of the optical block 7 having a radius of curvature of 1 m.

The dimensions of the gaussian beam associated with the TEM₀₀ fundamental mode in such a resonator are 247.8 μm in the plane of the resonator and 297 μm in the plane perpendicular to the latter, respectively. These values correspond to the waist radius of said fundamental mode.

As regards the mirrors, the dimensions of the mode radius are 257 and 303 μm, respectively.

We will now examine, with reference to FIGS. 6 and 7, how the emitted laser power in the ring varies with various parameters of the device of the invention.

The example shown in FIG. 6 relates to a crystal block (such as the block 14 shown in FIG. 3) made of Nd:YVO₄ with a thickness of 500 μm, coated with an Rmax coating (ensuring maximum reflection at the working wavelength of the laser) on one of its large faces and with an antireflection coating on the other large face, for a 45° angle of incidence of the laser beam. The Rmax coating (for a wavelength of 1.064 μm) must also be adapted so that the pumping beam (at 0.808 μm in the present example) can be effectively coupled to the active medium (the microwafer 26 in FIG. 3). The variation in the threshold incident pumping power (the minimum power needed to sustain the laser oscillation) may be evaluated as a function of the reflection coefficient of the output mirror (the mirror 24). It is accepted that the losses in the optical path (losses at the Rmax relay mirrors 23 and 25 and diffraction losses) are 0.5%. The array of curves in FIG. 6 shows the variation in emitted laser power in watts (laser oscillation) as a function of pumping power (also in watts) and of the reflection coefficient of the output mirror, the length of the cavity-forming ring being 40 cm (four successive channels each 10 cm in length).

FIG. 7 pertains to a structure similar to that relating to FIG. 6, the only difference being that the Nd:YVO₄ crystal has a thickness of 1 mm.

The curves shown in FIGS. 6 and 7 provide an appreciation of the way in which the external differential efficiency (as seen from the pump) varies with the power level of the pump and with the reflection coefficient of the output mirror. The overall efficiency is of the order of 10%. This is due to the size of the cavity mode (TEM₀₀ fundamental mode), which is relatively long and set by the length of each of the arms of the resonator.

The scale factor F for an annular cavity of square outline is given by the equation:

F=2πL_{cav}/λ,

L_{cav} being the total length of the cavity. Thus, for example, if L_{cav}=40 cm and λ=1.064 μm, then F=2.36×10⁶.

By increasing the radius of curvature of the mirrors (23 through 25 and 26A), it is possible to reduce the size of the cavity mode.

Thus, by optimizing the size of the pumped microwafer area, it is possible to minimize the optical pumping power to be used.

The advantage of the device of the invention as regards laser gyros lies in the fact that the power supply for a diode pump laser requires an electrical voltage of the order of magnitude of the bandgap energy of the semiconductor compound employed. Typically, at a wavelength of 0.8 μm, this voltage is about 1.5 V: The level of optical power delivered is determined only by the injection of current into the diode laser. The optical/electrical conversion efficiency is typically about 50%. Thus, if the pump power level needed to sustain the laser oscillation is 500 mW, the electrical power consumed is about 1 W.

When a single diode pump laser is used, this may be coupled directly (by physical contact) or via a microoptic of the “cylindrical (semicylindrical) lens” type making it possible to correct the divergence of the pump beam emitted in a direction perpendicular to the junction.

If the operating wavelength lies in the near infrared (about 1 μm), the scattering effects at the mirrors, if this scattering is governed by a Rayleigh-type process, are reduced, but this results in a reduction in the phase accumulation phenomenon in an interferometer setup.

FIG. 8 shows the basic diagram of a gyro structure 36 whose ring cavity has a triangular shape. The optical block 37 in which the optical cavity is formed is an optical plate whose outline is in the form of an isosceles or equilateral triangle, the three vertices of which have been removed in such a way that the small lateral faces 38, 39 and 40 thus exposed are perpendicular to the bisectors of the angles of the triangle. Three channels 41, 42 and 43 are drilled in this block to form the cavity, these channels joining the respective centers of the surfaces 38 through 40. Fixed to two of the faces, for example 38 and 39, is a respective wafer 44, 45 of active material (like the wafer 26). Each of these two wafers is coupled to a diode pump laser, 46, 47, respectively.

In all the embodiments described above, it is possible to use, as active medium, one or more microwafers of semiconductor materials excited directly by carrier injection. As a variant, it is possible to use a semi-VCSEL diode laser in which the external Bragg mirror is replaced with an antireflection coating. In such a case, this component acts as gain region and the resonator sets the frequency and spatial filtering conditions.

The device of the invention allows the cost of a laser gyro to be reduced and both its design and manufacture to be considerably simplified. Based on quantum-well GaInAIP compounds operating at a wavelength of about 0.65 μm, the increase in sensitivity owing to the use of a short wavelength allows all-solid-state optical gyros to be produced. If materials and structures are used for which the gain curve is matched to the wavelength of the He—Ne gas laser operating at a wavelength of 0.6328 μm, the technologies used for the cavity mirrors may be retained.

1. A solid-state laser gyro comprising:
a solid-state resonator block in which an optical path followed by two counterrotating waves generated by an optical-gain laser medium, is defined, wherein the resonator block is planar and in that the optical gain laser medium is attached to the resonator block.

2. The solid-state laser gyro as claimed in claim 1, wherein the resonator block is a block of undoped passive material.

3. The solid-state laser gyro as claimed in claim 1 wherein the resonator block is a block of passive material in which channels are machined.

4. The solid-state laser gyro as claimed in claim 1, wherein the gain medium comprises a preferably polarized emission material and is pumped by a laser source.

5. The solid-state laser gyro as claimed in claim 4, wherein the gain medium is a rare-earth-doped crystal.

6. The solid-state laser gyro as claimed in claim 4, wherein the gain medium is a semiconductor pumped directly by electrical means.

7. The solid-state laser gyro as claimed in claim 4 wherein the gain medium is a uniaxial crystal of yttrium vanadate doped with the rare earth ion Nd^{'+}.

8. The solid-state laser gyro as claimed in claim 1, wherein the gain medium is Nd:YAG.

9. The solid-state laser gyro as claimed in claim 1, wherein the resonator block is made of a material having a low thermal expansion coefficient.

10. The solid-state laser gyro as claimed in claim 1, wherein the resonator block is made of “ZERODUR”.
